(19) United States
(12) Patent Application Publication
(10) Pub. No.: US 2024/0083402 A1
(43) Pub. Date: Mar. 14, 2024

(54) ELECTRONIC BRAKE SYSTEM

(71) Applicant: HL MANDO CORPORATION, Gyeonggi-do (KR)

(72) Inventor: Jinseok KIM, Gyeonggi-do (KR)

(21) Appl. No.: 18/270,193

(22) PCT Filed: Dec. 29, 2021
(86) PCT No.: PCT/KR2021/020220

§ 371 Date: Jun. 28, 2023

(30) Foreign Application Priority Data
Dec. 29, 2020 (KR) 10-2020-0185729

(51) Int. Cl. B60T 8/94; B60T 7/04; B60T 7/12; B60T 8/34; B60T 8/40; B60T 13/14; B60T 13/62; B60T 13/68; B60T 13/74

(52) U.S. Cl. CPC B60T 8/94; B60T 7/042; B60T 7/12; B60T 8/344; B60T 8/4081; B60T 13/142; B60T 13/148; B60T 13/62; B60T 13/686; B60T 13/745

(57) ABSTRACT

An electronic brake system is disclosed. An electronic brake system according to the present embodiment comprises: a first block in which a device part linked with a brake pedal and mechanically operated is disposed; a second block in which an electronic part electronically operated and controlled by means of an electronic control unit is disposed; an emergency module operated, if the electronic part is disabled, to supportively provide hydraulic pressure; and a connecting line for hydraulically connecting the first block, the second block and the emergency module, wherein the first block, the second block and the emergency module can be provided at positions spaced from each other in a vehicle, and thus the mountability of the brake system and the freedom of design of the vehicle can be improved.

### TECHNICAL FIELD

The present invention relates to an electronic brake system, and more particularly, to an electronic brake system for generating a braking force using an electrical signal in response to a displacement of a brake pedal.

### BACKGROUND ART

In vehicles, a brake system for braking is necessarily installed, and various types of brake systems have been suggested for the safety of drivers and passengers.

In brake systems in the related art, a method in which, when a driver presses a brake pedal, hydraulic pressure required for braking is supplied to a wheel cylinder using a mechanically connected booster is mainly used. However, as a market demand to implement various braking functions by responding in detail to a vehicle operating environment increases, electronic brake systems that receive a driver's willingness to brake as an electrical signal from a pedal displacement sensor for detecting a displacement of a brake pedal when the driver presses the brake pedal and operate a hydraulic pressure supply device based on the electrical signal so that hydraulic pressure required for braking is supplied to a wheel cylinder have recently been widely spread.

Such an electronic brake system generates and provides a driver's brake pedal operation as an electrical signal in a normal operating mode, and the hydraulic pressure supply device is electrically operated and controlled based on the electrical signal, thereby generating hydraulic pressure required for braking and transmitting the hydraulic pressure to the wheel cylinder. As described above, the electronic brake system is electrically operated and controlled, and thus the electronic brake system may implement complex and various braking actions, but when a technical problem occurs in an electric component element, the hydraulic pressure required for braking is not stably generated, which may threaten the safety of occupants.

Accordingly, when one component element is broken or out of control, the electronic brake system enters an abnormal operating mode, and in this case, a mechanism in which a driver's brake pedal operation is directly linked to the wheel cylinder is required. That is, in the abnormal operating mode of the electronic brake system, it is required that, when the driver applies a pressing force to the brake pedal, the hydraulic pressure required for braking is immediately generated and transmitted directly to the wheel cylinder.

Meanwhile, in mounting the electronic brake system on a vehicle, there is a problem in that the degree of freedom in vehicle design is limited due to limitations in size and installation position of a system module. Accordingly, a method capable of efficiently installing a system module while maintaining braking performance of a vehicle is required.

### Technical Problem

The present embodiment is directed to providing an electronic brake system capable of effectively implementing braking in various operating situations.

The present embodiment is directed to providing an electronic brake system with improved performance and operational reliability.

The present embodiment is directed to providing an electronic brake system capable of providing a stable pedal feeling to a driver in various operating situations.

The present embodiment is directed to providing an electronic brake system capable of improving the degree of freedom in vehicle design.

The present embodiment is directed to providing an electronic brake system capable of easily and efficiently performing installation and arrangement in a vehicle.

### Technical Solution

According to one aspect of the present invention, there is provided an electronic brake system including a first block in which a mechanical part mechanically operated in conjunction with a brake pedal is disposed, a second block in which an electronic part electronically operated and controlled by an electronic control unit is disposed, wherein the second block is spaced apart from the first block, an emergency module configured to operate when the electronic part is inoperative and provide hydraulic pressure to a wheel cylinder in an auxiliary manner, and a connecting line hydraulically connecting the first block, the second block, and the emergency module to each other, in which the mechanical part includes a master cylinder equipped with a first master piston connected to the brake pedal, a first master chamber whose volume is varied by a displacement of the first master piston, a second master piston provided to be displaceable by hydraulic pressure of the first master chamber, and a second master chamber whose volume is varied by a displacement of the second master piston, the electronic part includes a pedal simulator, a hydraulic pressure supply device configured to generate hydraulic pressure by operating a hydraulic piston by an electrical signal output in response to a displacement of the brake pedal or an electrical signal output from the electronic control unit, and a hydraulic pressure control unit equipped with a first hydraulic circuit configured to control hydraulic pressure transmitted to first and second wheel cylinders, and a second hydraulic circuit configured to control hydraulic pressure transmitted to third and fourth wheel cylinders, and the connecting line includes a first connecting line having one end connected to the first master chamber and the other end connected to the first hydraulic circuit and a second connecting line having one end connected to the second master chamber and the other end branched and connected to each of the pedal simulator and the second hydraulic circuit.

The electronic part may further include a sub reservoir in which a pressurized medium is stored, the emergency module may include a hydraulic pressure auxiliary device configured to operate when the hydraulic pressure supply device is inoperative and provide hydraulic pressure to the wheel cylinder, and the connecting line may further include a third connecting line having one end connected to the sub reservoir and the other end connected to the hydraulic pressure auxiliary device.

The mechanical part may further include a main reservoir in which the pressurized medium is stored, and the connecting line may further include a fourth connecting line one end connected to the main reservoir and the other end connected to the sub reservoir.

The other end of the second connecting line may be branched into a simulation line connected to a front end of the pedal simulator and a backup line connected to the second hydraulic circuit, and the electronic part may further include a first cut valve provided in the first connecting line to control a flow of a pressurized medium and a second cut valve provided in the backup line to control the flow of the pressurized medium.

The hydraulic pressure auxiliary device may be provided between the first and second wheel cylinders and the first hydraulic circuit.

The hydraulic pressure auxiliary device may include a first isolation valve and a second isolation valve configured to allow and block flows of the pressurized medium transmitted from the master cylinder and the hydraulic pressure supply device to the first wheel cylinder and the second wheel cylinder, respectively, a pump configured to pressurize the pressurized medium, a motor configured to drive the pump, a first auxiliary hydraulic flow path for transmitting the pressurized medium pressurized by the pump to the first wheel cylinder, and a second auxiliary hydraulic flow path for transmitting the pressurized medium pressurized by the pump to the second wheel cylinder.

The hydraulic pressure auxiliary device may further include a first auxiliary dump flow path for discharging the pressurized medium applied to the first wheel cylinder and a second auxiliary dump flow path for discharging the pressurized medium applied to the second wheel cylinder.

The hydraulic pressure auxiliary device may further include a first support valve provided on the first auxiliary hydraulic flow path to control the flow of the pressurized medium and a second support valve provided on the second auxiliary hydraulic flow path to control the flow of the pressurized medium.

The hydraulic pressure auxiliary device may further include a first discharge valve provided on the first auxiliary dump flow path to control the flow of the pressurized medium and a second discharge valve provided on the second auxiliary dump flow path to control the flow of the pressurized medium.

The other end of the third connecting line may be connected to an inlet of the pump and the first and second auxiliary dump flow paths.

The electronic part may further include a first sub reservoir flow path connecting the sub reservoir and a rear end of the first hydraulic circuit and a second sub reservoir flow path connecting the sub reservoir and a rear end of the second hydraulic circuit.

The electronic part may further include a simulation flow path connected to a rear end of the pedal simulator, and the simulation flow path is connected to the sub reservoir by joining the second sub reservoir flow path.

The electronic part may further include a dump controller provided between the sub reservoir and the hydraulic pressure supply device to control the flow of the pressurized medium and a third sub reservoir flow path connecting the sub reservoir and the dump controller.

The first hydraulic circuit may include a first inlet valve and a second inlet valve configured to control the flow of the pressurized medium supplied from the hydraulic pressure supply device to the first wheel cylinder and the second wheel cylinder, respectively, and a first outlet valve and a second outlet valve configured to control flows of the pressurized medium discharged from the first wheel cylinder and the second wheel cylinder, respectively, the second hydraulic circuit may include a third inlet valve and a fourth inlet valve configured to control flows of the pressurized medium supplied from the hydraulic pressure supply device to the third wheel cylinder and the fourth wheel cylinder, respectively, and a third outlet valve and a fourth outlet valve configured to control flows of the pressurized medium discharged from the third wheel cylinder and the fourth wheel cylinder, respectively, the pressurized medium discharged through the first and second outlet valves may be supplied to the first sub reservoir flow path, and the pressurized medium discharged through the third and fourth outlet valves may be supplied to the second sub reservoir flow path.

The first connecting line and the second connecting line may be provided as pipes having rigidity, and the third connecting line and the fourth connecting line may be provided as hoses having elasticity.

### Advantageous Effects

An electronic brake system according to the present embodiment can stably and effectively implement braking in various operating situations of a vehicle.

An electronic brake system according to the present embodiment can improve product performance and operation reliability.

An electronic brake system according to the present embodiment can stably provide braking pressure even when a component element fails.

An electronic brake system according to the present embodiment can improve the degree of freedom in vehicle design.

An electronic brake system according to the present embodiment can easily and efficiently perform installation and arrangement in a vehicle.

An electronic brake system according to the present embodiment can provide a stable pedal feeling to a driver in various operating situations.

### DESCRIPTION OF DRAWINGS

FIG. 1 is a hydraulic circuit diagram illustrating an electronic brake system according to an exemplary embodiment of the present invention.

FIG. 2 is a hydraulic circuit diagram illustrating a state in which the electronic brake system according to an exemplary embodiment of the present invention performs a normal operating mode.

FIG. 3 is a hydraulic circuit diagram illustrating a state in which the electronic brake system according to an exemplary embodiment of the present invention releases the normal operating mode.

FIG. 4 is a hydraulic circuit diagram illustrating a state in which the electronic brake system according to an exemplary embodiment of the present invention performs a first fullback mode.

FIG. 5 is a hydraulic circuit diagram illustrating a state in which the electronic brake system according to an exemplary embodiment of the present invention releases the first fallback mode.

FIG. 6 is a hydraulic circuit diagram illustrating a state in which a second fallback mode is performed when a hydraulic pressure supply device and a hydraulic pressure auxiliary device of the electronic brake system according to an exemplary embodiment of the present invention are stopped.

FIG. 7 is a hydraulic circuit diagram illustrating a state in which the electronic brake system according to an exemplary embodiment of the present invention releases the second fallback mode.

### MODES OF THE INVENTION

Hereinafter, exemplary embodiments of the present invention will be described in detail with reference to the accompanying drawings. The following embodiments are provided to completely convey the spirit of the present invention to those skilled in the art to which the present invention pertains. The present invention is not limited to the embodiments shown herein and may be embodied in other forms. In the drawings, parts that bear no relation to descriptions may be omitted in order to clarify the present invention, and elements may be exaggerated in sizes thereof for ease of understanding.

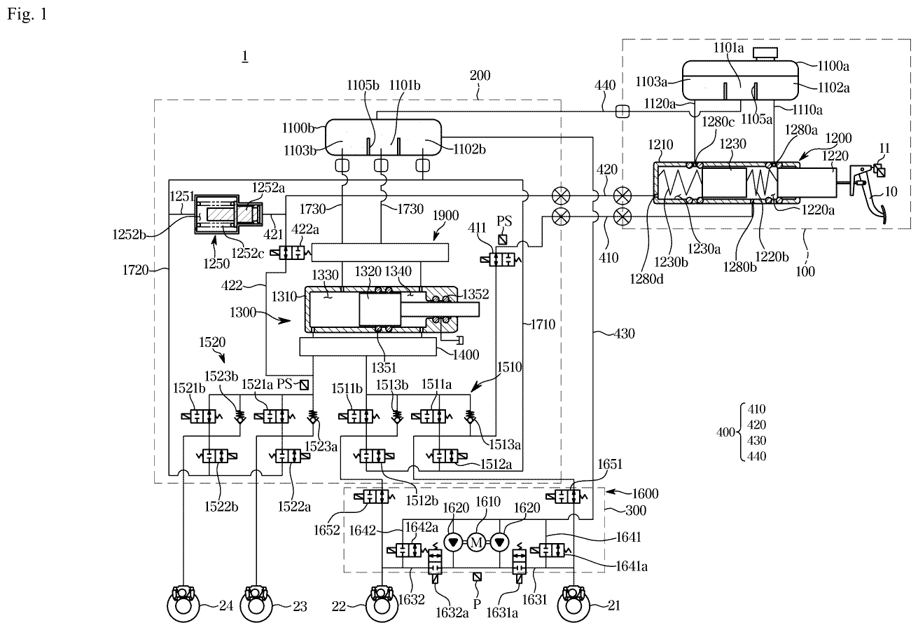

FIG. 1 is a hydraulic circuit diagram illustrating an electronic brake system 1 according to an exemplary embodiment of the present invention.

Referring to FIG. 1, the electronic brake system 1 according to an exemplary embodiment of the present invention may be provided to include a first block 100 in which a mechanical part that is mechanically operated is disposed, a second block 200 in which an electronic part that is electronically operated and controlled is disposed, an emergency module 300 that operates when the electronic part is inoperative and provides hydraulic pressure in an auxiliary manner, and a plurality of connecting lines 400 that hydraulically connect the first block 100, the second block 200, and the emergency module 300 to each other.

In the first block 100, the mechanical part that mechanically operates in connection or conjunction with a brake pedal 10 is disposed, and in the second block 200, the electronic part that is electronically operated and controlled, such as a valve and a sensor whose operations are controlled by an electronic control unit (not illustrated), is disposed. The first block 100 and the second block 200 may be disposed to be spaced apart from each other in a vehicle, but hydraulically connected by the plurality of connecting lines 400, thereby improving vehicle mountability of the electronic brake system 1, and furthermore, allowing efficient spatial arrangement by promoting the degree of freedom in vehicle design. In addition, the emergency module 300 may be disposed together on the second block 200 or disposed in the vehicle in a state of being spaced apart from the second block 200.

The mechanical part may include component elements that perform mechanical operations in conjunction with the brake pedal 10 regardless of a control signal of the electronic control unit, and may be disposed in the first block 100.

The mechanical part may include a main reservoir 1100a in which a pressurized medium such as brake oil is stored, a master cylinder 1200 that pressurizes and discharges a pressurized medium such as brake oil accommodated therein according to a pressing force of the brake pedal 10, and main reservoir flow paths 1110a and 1120a connecting the main reservoir 1100a and the master cylinder 1200.

The master cylinder 1200 may be configured to include at least one hydraulic chamber, and thus pressurize and discharge the pressurized medium therein. The master cylinder 1200 may include a first master chamber 1220a, a second master chamber 1230a, and a first master piston 1220 and a second master piston 1230 provided in the master chambers 1220a and 1230a, respectively.

The first master chamber 1220a may be formed on an inlet side (a right side of FIG. 1) of a cylinder block 1210 to which the brake pedal 10 is connected, and in the first master chamber 1220a, the first master piston 1220 may be accommodated to be reciprocally movable.

The pressurized medium may be introduced into and discharged from the first master chamber 1220a through a first hydraulic port 1280a and a second hydraulic port 1280b. The first hydraulic port 1280a may be connected to a first main reservoir flow path 1110a to be described below so that the pressurized medium is introduced into the first master chamber 1220a from the main reservoir 1100a, and a pair of sealing members may be provided at the front (a left side of FIG. 1) and the rear (the right side of FIG. 1) of the first hydraulic port 1280a to seal the first master chamber 1220a. The second hydraulic port 1280b may be connected to a first connecting line 410 to be described below so that the pressurized medium in the first master chamber 1220a is discharged to the first connecting line 410 or, conversely, the pressurized medium is introduced into the first master chamber 1220a from the first connecting line 410.

The first master piston 1220 may be provided to be accommodated in the first master chamber 1220a, and may pressurize the pressurized medium accommodated in the first master chamber 1220a by moving forward and generate a negative pressure in the first master chamber 1220a by moving backward. Specifically, as a volume of the first master chamber 1220a is decreased when the first master piston 1220 moves forward, the pressurized medium present in the first master chamber 1220a may be pressurized, and thus hydraulic pressure may be generated. Conversely, as the volume of the first master chamber 1220a is increased when the first master piston 1220 moves backward, the pressurized medium present in the first master chamber 1220a may be depressurized, and at the same time, the negative pressure may be generated in the first master chamber 1220a.

The second master chamber 1230a may be formed on the front side (the left side of FIG. 1) of the first master chamber 1220a on the cylinder block 1210, and in the second master chamber 1230a, the second master piston 1230 may be accommodated to be reciprocally movable.

The pressurized medium may be introduced into and discharged from the second master chamber 1230a through a third hydraulic port 1280c and a fourth hydraulic port 1280d. The third hydraulic port 1280c may be connected to a second main reservoir flow path 1120a to be described below so that the pressurized medium is introduced into the second master chamber 1230a from the main reservoir 1100a, and a pair of sealing members may be provided at the front (the left side of FIG. 1) and the rear (the right side of FIG. 1) of the third hydraulic port 1280c to seal the second master chamber 1230a. The fourth hydraulic port 1280d may be connected to a third connecting line 430 to be described below so that the pressurized medium in the second master chamber 1230a is discharged to the third connecting line 430, or, conversely, the pressurized medium is introduced into the second master chamber 1230a from the third connecting line 430.

The second master piston 1230 may be provided to be accommodated in the second master chamber 1230a, may pressurize the pressurized medium accommodated in the second master chamber 1230a by moving forward, and may generate a negative pressure in the second master chamber 1230a by moving backward. Specifically, as a volume of the second master chamber 1230a is decreased when the second master piston 1230 moves forward, the pressurized medium present in the second master chamber 1230a may be pressurized, and thus hydraulic pressure may be generated. Conversely, as the volume of the second master chamber 1230a is increased when the second master piston 1230 moves backward, the pressurized medium present in the second master chamber 1230a may be depressurized, and at the same time, the negative pressure may be generated in the second master chamber 1230a.

A first piston spring 1220b and a second piston spring 1230b are provided to elastically support the first master piston 1220 and the second master piston 1230, respectively. To this end, the first piston spring 1220b may be disposed between a front surface (a left end of FIG. 1) of the first master piston 1220 and a rear surface (a right end of FIG. 1) of the second master piston 1230, and the second piston spring 1230b may be disposed between a front surface (the left end of FIG. 1) of the second master piston 1230 and an inner surface of the cylinder block 1210. When displacements occur in the first master piston 1220 and the second master piston 1230 according to an operation such as braking, the first piston spring 1220b and the second piston spring 1230b may be compressed, respectively, and then, when the operation such as braking is released, the first master piston 1220 and the second master piston 1230 may return to their original positions while the first piston spring 1220b and the second piston spring 1230b expand by elastic force, respectively.

The main reservoir 1100a may accommodate and store the pressurized medium therein. The main reservoir 1100a may be connected to component elements such as the master cylinder 1200 and a fourth connecting line 440 to be described below to supply or receive the pressurized medium.

The main reservoir 1100a may be provided to be partitioned into a plurality of chambers by partition walls 1105a. The main reservoir 1100a may include a plurality of main reservoir chambers 1101a, 1102a, and 1103a, and the plurality of main reservoir chambers 1101a, 1102a, and 1103a may be arranged side by side in a row. Specifically, the main reservoir 1100a may be divided into a first main reservoir chamber 1101a disposed at the center, a second main reservoir chamber 1102a disposed on one side, and a third main reservoir chamber 1103a disposed on the other side.

Each partition wall 1105a may be provided between adjacent main reservoir chambers, and at least a part of an upper end of each partition wall 1105a may be provided with an open top. Thereby, the adjacent main reservoir chambers 1101a, 1102a, and 1103a may communicate with each other so that the pressurized medium moves. For example, when a large amount of pressurized medium is introduced into the first main reservoir chamber 1101a, the pressurized medium may be transmitted to the second main reservoir chamber 1102a or the third main reservoir chamber 1103a by passing through the upper end of the partition wall 1105a.

The first main reservoir chamber 1101a may be connected to the fourth connecting line 440 to be described below and supply the pressurized medium to a sub reservoir 1100b or receive the pressurized medium from the sub reservoir 1100b. In addition, the second main reservoir chamber 1102a may be connected to the first main reservoir flow path 1110a to be described below and the third main reservoir chamber 1103a may be connected to the second main reservoir flow path 1120a, and thus the second main reservoir chamber 1102a and the third main reservoir chamber 1103a may supply or receive the pressurized medium toward or from the master cylinder 1200.

In this way, since the main reservoir 1100a is provided to be partitioned into the first to third main reservoir chambers 1101a, 1102a, and 1103a, stable operation of the electronic brake system 1 may be promoted. For example, when the main reservoir 1100a is formed as a single chamber and the capacity of the pressurized medium is insufficient, it is not possible to stably supply the pressurized medium to the master cylinder 1200 as well as the sub reservoir 1100b. Therefore, by providing the main reservoir 1100a in which the first main reservoir chamber 1101a connected to the sub reservoir 1100b of the electronic part and the second and third main reservoir chambers 1102a and 1103a connected to the master cylinder 1200 are separated, even when the pressurized medium is not supplied to any one component element, it is possible to supply the pressurized medium to another component element, thereby implementing braking of the vehicle.

The main reservoir flow path is provided to hydraulically connect the master cylinder 1200 and the main reservoir 1100a.

The reservoir flow path may include the first reservoir flow path 1110a connecting the first master chamber 1220a and the second reservoir chamber 1102a of the main reservoir 1100a and the second reservoir flow path 1120a connecting the second master chamber 1230a and the third reservoir chamber 1103a of the main reservoir 1100a. To this end, one end of the first main reservoir flow path 1110a may communicate with the first master chamber 1220a of the master cylinder 1200 and the other end thereof may communicate with the second reservoir chamber 1102a of the main reservoir 1100a, and one end of the second main reservoir flow path 1120a may communicate with the second master chamber 1230a of the master cylinder 1200 and the other end thereof may communicate with the third reservoir chamber 1103a of the main reservoir 1100a.

The electronic part may include component elements that are electronically operated and controlled by a control signal of the electronic control unit (ECU, not illustrated), and may be disposed in the second block 200.

The electronic part may include an electronic control unit, the sub reservoir 1100b in which the pressurized medium is stored for auxiliary purposes, a pedal simulator 1250 providing a reaction force to a driver's pressing force to the brake pedal 10, a hydraulic pressure supply device 1300 for receiving a driver's willingness to brake as an electrical signal by a pedal displacement sensor 11 for detecting a displacement of the brake pedal 10 and generating hydraulic pressure of the pressurized medium through mechanical operation, a hydraulic pressure control unit 1400 for controlling the hydraulic pressure provided by the hydraulic pressure supply device 1300 and the hydraulic pressure transmitted to the first to fourth wheel cylinders 21, 22, 23, and 24, a dump controller 1900 for hydraulically connecting the sub reservoir 1100b and the hydraulic pressure supply device 1300 and controlling a flow of a pressurized medium between the sub reservoir 1100b and the hydraulic pressure supply device 1300, a plurality of sub reservoir flow paths 1710, 1720, and 1730 connecting the sub reservoir 1100b to the first and second hydraulic circuits 1510 and 1520 and the dump controller 1900, and a plurality of cut valves 411 and 422a provided in a connecting line to be described below and controlling the flow of the pressurized medium.

The sub reservoir 1100b may be disposed in the second block 200 and store the pressurized medium for auxiliary purposes. As the pressurized medium is stored even in the electronic part by the sub reservoir 1100b for auxiliary purposes, the pressurized medium may be smoothly supplied and transmitted through the hydraulic pressure supply device 1300, the dump controller 1900, the first and second hydraulic circuits 1510 and 1520, and the like, even in the electronic part.

The sub reservoir 1100b may be connected to the hydraulic pressure auxiliary device 1600 of the emergency module 300 by the third connecting line 430 to be described below and connected to the main reservoir 1100a of the mechanical part by the fourth connecting line 440. In addition, the sub reservoir 1100b may be connected to the first hydraulic circuit 1510 and the second hydraulic circuit 1520 by a first sub reservoir flow path 1710 and a second sub reservoir flow path 1720 to be described below, respectively, and connected to the dump controller 1900 by a third sub reservoir flow path 1730.

The hydraulic pressure supply device 1300 is provided to implement a reciprocating movement of the hydraulic piston 1320 by receiving a driver's willingness to brake as an electrical signal from the pedal displacement sensor 11 for detecting the displacement of the brake pedal 10, and generate hydraulic pressure of the pressurized medium through the movement.

The hydraulic pressure supply device 1300 may include a hydraulic pressure providing unit that provides a pressure of the pressurized medium transmitted to the wheel cylinders and a power provider (not illustrated) that generates power of the hydraulic piston 1320 based on an electrical signal of the pedal displacement sensor 11.

The hydraulic pressure providing unit includes a cylinder block 1310 provided to allow the pressurized medium to be accommodated therein, the hydraulic piston 1320 accommodated in the cylinder block 1310, and a sealing member provided between the hydraulic piston 1320 and the cylinder block 1310 to seal a pressure chamber.

The pressure chamber may include a first pressure chamber 1330 positioned at the front of the hydraulic piston 1320 (a left direction of the hydraulic piston 1320 in FIG. 1) and a second pressure chamber 1340 positioned at the rear of the hydraulic piston 1320 (a right direction of the hydraulic piston 1320 in FIG. 1). That is, the first pressure chamber 1330 is provided to be partitioned by the cylinder block 1310 and a front surface of the hydraulic piston 1320 so that a volume thereof is varied according to the movement of the hydraulic piston 1320, and the second pressure chamber 1340 is provided to be partitioned by the cylinder block 1310 and a rear surface of the hydraulic piston 1320 so that a volume thereof is varied according to the movement of the hydraulic piston 1320.

The first pressure chamber 1330 may be hydraulically connected to the hydraulic pressure control unit 1400 to be described below by the hydraulic flow path, and the second pressure chamber 1340 may also be hydraulically connected to the hydraulic pressure control unit 1400 by the hydraulic flow path.

The sealing member includes a piston sealing member 1351 provided between the hydraulic piston 1320 and the cylinder block 1310 to seal between the first pressure chamber 1330 and the second pressure chamber 1340 and a driving shaft sealing member 1352 provided between the power provider and the cylinder block 1310 to seal an opening of the second pressure chamber 1340 and the cylinder block 1310. A hydraulic pressure or negative pressure of the first pressure chamber 1330 and the second pressure chamber 1340 generated by forward or backward movement of the hydraulic piston 1320 may be sealed by the piston sealing member 1351 and the driving shaft sealing member 1352 and transmitted to the hydraulic flow path without leakage.

The power provider may generate and provide power to the hydraulic piston 1320 by an electrical signal. For example, the power provider may include a motor (not illustrated) for generating a rotational force and a power converter (not illustrated) for converting the rotational force of the motor into a translational movement of the hydraulic piston 1320, but the power provider is not limited to the structure and device.

The hydraulic pressure control unit 1400 is provided between the hydraulic pressure supply device 1300 and the wheel cylinders and provided so that the operation thereof is controlled by the electronic control unit to adjust the hydraulic pressure transmitted toward the wheel cylinders 21, 22, 23, and 24.

The hydraulic pressure control unit 1400 may be equipped with a first hydraulic circuit 1510 for controlling the flow of the hydraulic pressure transmitted to first and second wheel cylinders 21 and 22 among the four wheel cylinders 21, 22, 23, and 24 and a second hydraulic circuit 1520 for controlling the flow of the hydraulic pressure transmitted to third and fourth wheel cylinders 23 and 24 and includes a plurality of flow paths and solenoid valves to control the hydraulic pressure transmitted from the master cylinder 1100 and the hydraulic pressure supply device 1300 to the wheel cylinders.

The first and second hydraulic circuits 1510 and 1520 may include first to fourth inlet valves 1511a, 1511b, 1521a, and 1521b to control the flow of the pressurized medium flowing toward the first to fourth wheel cylinders 21, 22, 23, and 24, respectively. The first to fourth inlet valves 1511a, 1511b, 1521a, and 1521b may be disposed upstream of the first to fourth wheel cylinders 21, 22, 23, and 24, respectively, and provided as normal open type solenoid valves that are open in normal times and operate to close when receiving an electrical signal from the electronic control unit.

The first and second hydraulic circuits 1510 and 1520 may include first to fourth check valves 1513a, 1513b, 1523a, and 1523b provided to be connected in parallel to the first to fourth inlet valves 1511a, 1511b, 1521a, and 1521b. The first to fourth check valves 1513a, 1513b, 1523a, and 1523b may be provided on the bypass flow path connecting the front and rear sides of the first to fourth inlet valves 1511a, 1511b, 1521a, and 1521b on the first and second hydraulic circuits 1510 and 1520 and allow only a flow of the pressurized medium discharged from the respective wheel cylinders and block a flow of the pressurized medium from the hydraulic pressure supply device 1300 to the wheel cylinders. The hydraulic pressure of the pressurized medium applied to the respective wheel cylinders may be quickly removed by the first to fourth check valves 1513a, 1513b, 1523a, and 1523b, and even when the first to fourth inlet valves 1511a, 1511b, 1521a, and 1521b do not operate normally, the hydraulic pressure of the pressurized medium applied to the wheel cylinders may be smoothly discharged.

The first hydraulic circuit 1510 may include first and second outlet valves 1512a and 1512b for adjusting the discharge of the pressurized medium to improve performance when braking of the first and second wheel cylinders 21 and 22 is released. When the braking pressure of the first and second wheel cylinders 21 and 22 is detected and decompression braking is required, such as in an ABS dump mode, the first and second outlet valves 1512a and 1512b may be selectively opened so that the pressurized medium applied to the first and second wheel cylinders 21 and 22 is discharged to the sub reservoir 1100b through the first sub reservoir flow path 1710 to be described below. The first and second outlet valves 1512a and 1512b may be provided as normal closed type solenoid valves that are closed in normal times and operate to open when receiving an electrical signal from the electronic control unit.

The second hydraulic circuit 1520 may include third and fourth outlet valves 1522a and 1522b for adjusting the discharge of the pressurized medium to improve performance when braking of the third and fourth wheel cylinders 23 and 24 is released. When the braking pressure of the third and fourth wheel cylinders 23 and 24 is detected and decompression braking is required, such as in the ABS dump mode, the third and fourth outlet valves 1522a and 1522b may be selectively opened so that the pressurized medium applied to the third and fourth wheel cylinders 23 and 24 is discharged to the sub reservoir 1100b through the second sub reservoir flow path 1720 to be described below. The third and fourth outlet valves 1522a and 1522b may be provided as normal closed type solenoid valves that are closed in normal times and operate to open when receiving an electrical signal from the electronic control unit.

The pedal simulator 1250 is provided to provide a reaction force to a driver's pressing force for operating the brake pedal 10.

The pedal simulator 1250 has a front end connected to a simulation line 421 of a second connecting line 420 to be described below, and a rear end connected to the sub reservoir 1100b by a simulation flow path 1251.

The pedal simulator 1250 includes a simulation piston 1252a provided to be displaceable by the pressurized medium introduced from the second connecting line 420, a simulation chamber 1252b whose volume is varied by the displacement of the simulation piston 1252a and that communicates with the simulation flow path 1251 positioned behind, and a simulation spring 1252c that elastically supports the simulation piston 1252a.

The simulation piston 1252a is provided to be displaceable in the simulation chamber 1252b by the pressurized medium introduced through the second connecting line 420. Specifically, the hydraulic pressure of the pressurized medium introduced through the second connecting line 420 may be transmitted to a front surface (a right surface in FIG. 1) of the simulation piston 1252a, so that a displacement occurs in the simulation piston 1252a, and as the volume of the simulation chamber 1252b formed on a rear surface (a left surface in FIG. 1) of the simulation piston 1252a is decreased due to the displacement of the simulation piston 1252a, the pressurized medium accommodated in the simulation chamber 1252b may be supplied to the sub reservoir 1100b by the simulation flow path 1251. Since the simulation spring 1252c elastically supports the simulation piston 1252a, the simulation spring 1252c is compressed according to the displacement of the simulation piston 1252a and an elastic restoring force corresponding thereto may be provided to the driver as a pedal feeling.

Meanwhile, in the drawing, the simulation spring 1252c is illustrated as being provided as a coil spring as an example, but in addition, various structures may be provided as long as the simulation piston 1252a is provided as an elastic force and an elastic restoring force at the same time. For example, the simulation piston 1252a may be made of a material such as rubber or made of various members capable of storing an elastic force such as a leaf spring.

The simulation flow path 1251 may be connected to the rear end of the pedal simulator 1250 and connected so that one end thereof communicates with the simulation chamber 1252b and the other end thereof joins the second sub reservoir flow path 1720 to be described below. By connecting the simulation chamber 1252b and the sub reservoir 1100b through the simulation flow path 1251, the pressurized medium discharged from the simulation chamber 1252b may be supplied to the sub reservoir 1100b, or conversely, the pressurized medium may be supplied from the sub reservoir 1100b to the simulation chamber 1252b.

Describing the operation of the pedal simulator 1250, when the driver applies the pressing force by operating the brake pedal 10, the first master piston 1220 and the second master piston 1230 move forward and thus the pressurized medium in the second master chamber 1112a is supplied and pressurized to a front surface of the simulation piston 1252a through the second connecting line 420 and the simulation line 421. As the displacement occurs in the simulation piston 1252a in this way, the simulation spring 1252c may be compressed, and the elastic restoring force of the simulation spring 1252c may be provided to the driver as the pedal feeling. In this case, the pressurized medium filled in the simulation chamber 1252b is transmitted to the sub reservoir 1100b through the simulation flow path 1251 and the second sub reservoir flow path 1720. Then, when the driver releases the pressing force of the brake pedal 10, the simulation spring 1252c expands by the elastic restoring force and the simulation piston 1252a returns to its original position, and the pressurized medium that presses the front surface of the simulation piston 1252a is returned to the second master chamber 1112a through the simulation line 421 and the second connecting line 420. The pressurized medium may be supplied to the simulation chamber 1252b from the sub reservoir 1100b by sequentially passing through the second sub reservoir flow path 1720 and the simulation flow path 1251, and the interior of the simulation chamber 1252b may be filled with the pressurized medium again.

As such, since the interior of the simulation chamber 1252b is always filled with the pressurized medium, the friction of the simulation piston 1252a may be minimized during operation of the pedal simulator 1250, and thus durability of the pedal simulator 1250 may be improved and introduction of foreign substances from the outside may be blocked.

The dump controller 1900 may be provided between the hydraulic pressure supply device 1300 and the sub reservoir 1100b to control the flow of the pressurized medium, and may include a plurality of flow paths and various solenoid valves for controlling the flow. The dump controller 1900 may have one side connected to the first pressure chamber 1330 and the second pressure chamber 1340 of the hydraulic pressure supply device 1300, and the other side connected to the sub reservoir 1100b by a third sub reservoir flow path 1730 to be described below. A plurality of solenoid valves provided in the dump controller 1900 are electrically operated and controlled by the electronic control unit.

The first pressure chamber 1330 and the second pressure chamber 1340 may be connected to the sub reservoir 1100b through the dump controller 1900. Through the dump controller 1900, the first pressure chamber 1330 and the second pressure chamber 1340 may receive the pressurized medium from the sub reservoir 1100b, or conversely, the pressurized medium accommodated in the first pressure chamber 1330 and the second pressure chamber 1340 may be transmitted to the sub reservoir 1100b.

The sub reservoir 1100b may be provided to be partitioned into a plurality of chambers by partition walls 1105b. The sub reservoir 1100b may include a plurality of sub reservoir chambers 1101b, 1102b, and 1103b, and the plurality of sub reservoir chambers 1101b, 1102b, and 1103b may be arranged side by side in a row. Specifically, the sub reservoir 1100b may be divided into a first sub reservoir chamber 1101b disposed at the center, a second sub reservoir chamber 1102b disposed on one side, and a third sub reservoir chamber 1103b disposed on the other side.

Each partition wall 1105b may be provided between adjacent sub reservoir chambers, and at least a part of an upper end of each partition wall 1105b may be provided with an open top. Thereby, the adjacent sub reservoir chambers 1101b, 1102b, and 1103b may communicate with each other so that the pressurized medium moves. For example, when a large amount of pressurized medium is introduced into the first sub reservoir chamber 1101b, the pressurized medium may be transmitted to the second sub reservoir chamber 1102b or the third sub reservoir chamber 1103b by passing through the upper end of the partition wall 1105b.

The first sub reservoir chamber 1101b and the third sub reservoir chamber 1102b may be connected to the dump controller 1900 and the second sub reservoir chamber may be connected to a third connecting line 430 and a fourth connecting line 440 to be described below and the first and second hydraulic circuits 1510 and 1520, and thus the pressurized medium may be transmitted to each other.

In this way, since the sub reservoir 1100b is provided to be partitioned into the first to third sub reservoir chambers 1101b, 1102b, and 1103b, stable operation of the electronic brake system 1 may be promoted. For example, when the sub reservoir 1100b is formed as a single chamber and the capacity of the pressurized medium is insufficient, it is not possible to stably supply the pressurized medium toward the dump controller 1900 and the hydraulic pressure supply device 1300 as well as the main reservoir 1100a. Therefore, by providing the sub reservoir 1100b in which the first to third sub reservoir chambers 1101b, 1102b, and 1103b are separated, even when the pressurized medium is not supplied to any one component element, it is possible to supply the pressurized medium to another component element, thereby implementing braking of the vehicle.

The sub reservoir flow path is provided to hydraulically connect the first hydraulic circuit 1510, the second hydraulic circuit 1520, and the hydraulic pressure supply device 1300 to the sub reservoir 1100b. The sub reservoir flow path may include a second sub reservoir flow path 1710 connecting the sub reservoir 1100b and a rear end of the first hydraulic circuit 1510, the second sub reservoir flow path 1720 connecting the sub reservoir 1100b and a rear end of the second hydraulic circuit 1520, and the third sub reservoir flow path 1730 connecting the sub reservoir 1100b and the dump controller 1900.

The first sub reservoir flow path 1710 may have one end connected to the second sub reservoir chamber 1102b of the sub reservoir 1100b and the other end connected to a downstream side of the first and second outlet valves 1512a and 1512b of the first hydraulic circuit 1510. In addition, the second sub reservoir flow path 1720 may have one end connected to the second sub reservoir chamber 1102b of the sub reservoir 1100b, and the other end connected to a downstream side of the third and fourth outlet valves 1522a and 1522b of the second hydraulic circuit 1520, and the simulation flow path 1251 may join a middle portion of the second sub reservoir flow path 1720. In addition, at least one third sub reservoir flow path 1730 may be provided, one end of the third sub reservoir flow path 1730 may be connected to the first and second sub reservoir chambers 1101b and 1102b of the sub reservoir 1100b, and the other end may be connected to the dump controller 1900.

The electronic part may include at least one first cut valve 411 provided on the first connecting line 410 to be described below to control the flow of a pressurized medium, and a second cut valve 422a provided in a backup line 422 of the second connecting line 420 to be described below to control the flow of the pressurized medium. A more detailed description thereof will be given below.

The electronic brake system 1 according to the present embodiment further includes a plurality of pressure sensors P disposed on various flow paths to detect the hydraulic pressure of the pressurized medium. In FIG. 1, the pressure sensors P are illustrated as being disposed on the second hydraulic circuit 1520 and the hydraulic pressure auxiliary device 1600 to be described below, respectively, but are not limited to those positions, and a case where the pressure sensors P are provided in various positions to detect the hydraulic pressure of the pressurized medium is included.

Meanwhile, when a malfunction such as a failure of the hydraulic pressure supply device 1300 of the electronic part or inability to control the hydraulic pressure control unit 1400 occurs, it is not possible to transmit hydraulic pressure to the wheel cylinders 21, 22, 23, and 24, and thus there is a problem that active braking of the vehicle is difficult. Accordingly, the electronic brake system 1 according to the present embodiment is provided with the emergency module 300 that operates and intervenes when the electronic part is inoperative due to a failure of the hydraulic pressure supply device 1300 or the like and provides hydraulic pressure of the pressurized medium in an auxiliary manner.

The emergency module 300 may include a hydraulic pressure auxiliary device 1600 that operates and intervenes when the electronic part, such as the hydraulic pressure supply device 1300, is inoperative, and be disposed together on the second block 200 where the electronic part is disposed, or mounted or installed on the vehicle in a state of being spaced apart from the second block 200.

The hydraulic pressure auxiliary device 1600 may be provided on the side closer to the first and second wheel cylinders 21 and 22 of the first hydraulic circuit 1510, and operate when the hydraulic pressure supply device 1300 is inoperative due to a failure or the like, and generate and provide hydraulic pressure required for braking of the first and second wheel cylinders 21 and 22. A mode in which the hydraulic pressure auxiliary device 1600 operates due to a malfunction of the hydraulic pressure supply device 1300 is referred to as a first fallback mode.

The hydraulic pressure auxiliary device 1600 includes a first isolation valve 1651 for controlling a flow of the pressurized medium transmitted from at least one of the master cylinder 1200 and the hydraulic pressure supply device 1300 to the first wheel cylinder 21, a second isolation valve 1652 for controlling a flow of the pressurized medium transmitted from at least one of the master cylinder 1200 or the hydraulic pressure supply device 1300 to the second wheel cylinder 22, a pair of pumps 1620 for pressurizing the pressurized medium, a motor 1610 for driving the pair of pumps 1620, a first auxiliary hydraulic flow path 1631 for transmitting the pressurized medium pressurized by the pumps 1620 to the first wheel cylinder 21, a second auxiliary hydraulic flow path 1632 for transmitting the pressurized medium pressurized by the pumps 1620 to the second wheel cylinder 22, a first support valve 1631a provided on the first auxiliary hydraulic flow path 1631 to control the flow of the pressurized medium, a second support valve 1632a provided on the second auxiliary hydraulic flow path 1632 to control the flow of the pressurized medium, a first auxiliary dump flow path 1641 for discharging the pressurized medium applied to the first wheel cylinder 21, a second auxiliary dump flow path 1642 for discharging the pressurized medium applied to the second wheel cylinder 22, a first discharge valve 1641a provided on the first auxiliary dump flow path 1641 to control the flow of the pressurized medium, and a second discharge valve 1642a provided on the second auxiliary dump flow path 1642 to control the flow of the pressurized medium.

Each of the first and second isolation valves 1651 and 1652 is provided to allow or block a hydraulic connection between at least any one of the master cylinder 1200 or the hydraulic pressure supply device 1300 and the first and second wheel cylinders 21 and 22.

When the hydraulic pressure of the pressurized medium generated by the pumps 1620 leaks toward the hydraulic pressure supply device 1300 during operation of the hydraulic pressure auxiliary device 1600, there is a risk of a safety accident because a braking level requested by the driver and a braking force actually generated in the first and second wheel cylinders 21 and 22 are different. In addition, when the hydraulic pressure generated and provided from the hydraulic pressure auxiliary device 1600 is not fully transmitted to the first and second wheel cylinders 21 and 22 and leaks to the other component element, there is a problem that rapid braking of the wheel cylinders is not implemented.

Accordingly, the first and second isolation valves 1651 and 1652 may allow a hydraulic connection of the master cylinder 1200 and the hydraulic pressure supply device 1300 and the first and second wheel cylinders 21 and 22 in the normal operating mode and the second fallback mode and block the hydraulic connection of the master cylinder 1200 and the hydraulic pressure supply device 1300 and the first and second wheel cylinders 21 and 22 in the first fallback mode where the hydraulic pressure auxiliary device 1600 operates.

The first isolation valve 1651 is provided between the first wheel cylinder 21 and a downstream side of the first inlet valve 1511a to allow or block the flow of the pressurized medium. The first isolation valve 1651 may be provided as a normal open type solenoid valve that is open in normal times and operates to open when receiving an electrical signal from the electronic control unit.

The second isolation valve 1652 is provided between the second wheel cylinder 22 and a downstream side of the second inlet valve 1512a to allow or block the flow of the pressurized medium. The second isolation valve 1652 may be provided as a normal open type solenoid valve that is open in normal times and operates to open when receiving an electrical signal from the electronic control unit.

When the electronic control unit determines a malfunction due to a failure of the hydraulic pressure supply device 1300 or the like, the electronic control unit switches the electronic brake system to the first fallback mode to close the first and second isolation valves 1651 and 1652 and operates the motor 1610. The motor 1610 may be operated by receiving a driver's willingness to brake as an electrical signal from the pedal displacement sensor 11 that detects the displacement of the brake pedal 10. The motor 1610 may operate the pair of pumps 1620 by receiving electric power from a battery or the like.

The pair of pumps 1620 may pressurize the pressurized medium according to a reciprocating movement of a piston (not illustrated) provided in the motor 1610. The pumps 1620 receive the pressurized medium from the third connecting line 430 connected to the sub reservoir 1100b, and pressurizes the pressurized medium to correspond to a hydraulic pressure level required for braking by operation of the motor 1610.

The pressurized medium of which the hydraulic pressure is generated by any one of the pair of pumps 1620 may be transmitted to the first wheel cylinder 21 by the first auxiliary hydraulic flow path 1631 provided as a discharge-side flow path of the pumps 1620. To this end, the first auxiliary hydraulic flow path 1631 may have an inlet-side end connected to a discharge side of the pumps 1620 and an outlet-side end connected to the first wheel cylinder 21, and the first support valve 1631a is provided on the first auxiliary hydraulic flow path 1631 to control a flow of the pressurized medium transmitted from the pumps 1620 to the first wheel cylinder 21. The first support valve 1631a may be provided as a normal closed type solenoid valve that is closed in normal times and operates to open when receiving an electrical signal from the electronic control unit. When the electronic brake system is switched to the first fallback mode, the electronic control unit may open the first support valve 1631a so that the hydraulic pressure of the pressurized medium discharged from the pumps 1620 is provided to the first wheel cylinder 21.

The pressurized medium of which the hydraulic pressure is generated by the other one of the pair of pumps 1620 may be transmitted to the second wheel cylinder 22 by the second auxiliary hydraulic flow path 1632 provided as the discharge-side flow path of the pumps 1620. To this end, the second auxiliary hydraulic flow path 1632 may have an inlet-side end connected to the discharge side of the pumps 1620 and an outlet-side end connected to the second wheel cylinder 22, and the second support valve 1632a is provided on the second auxiliary hydraulic flow path 1632 to control a flow of the pressurized medium transmitted from the pumps 1620 to the second wheel cylinder 22. Like the first support valve 1631a, the second support valve 1632a may be provided as a normal closed type solenoid valve that is closed in normal times and operates to open when receiving an electrical signal from the electronic control unit. When the electronic brake system is switched to the first fallback mode, the electronic control unit may open the second support valve 1632a so that the hydraulic pressure of the pressurized medium discharged from the pumps 1620 is provided to the second wheel cylinder 22.

The pressurized medium applied to the first wheel cylinder 21 may be discharged through the first auxiliary dump flow path 1641. To this end, the first auxiliary dump flow path 1641 may have one end connected to a first wheel cylinder 21 side or the first auxiliary hydraulic flow path 1631 downstream of the first support valve 1631a and the other end connected to the sub reservoir 1100b through the third connecting line 430 to be described below or connected to the inlet side of the pumps 1620. The first discharge valve 1641a for controlling a flow of the pressurized medium discharged from the first wheel cylinder 23 is provided on the first auxiliary dump flow path 1641. The first discharge valve 1641a may be provided as a normal closed type solenoid valve that is closed in normal times and operates to open when receiving an electrical signal from the electronic control unit.

The pressurized medium applied to the second wheel cylinder 22 may be discharged through the second auxiliary dump flow path 1642. To this end, the second auxiliary dump flow path 1642 may have one end connected to a second wheel cylinder 22 side or the second auxiliary hydraulic flow path 1632 downstream of the second support valve 1632a and the other end connected to the sub reservoir 1100b through the third connecting line 430 to be described below or connected to the inlet side of the pumps 1620. The second discharge valve 1642a for controlling a flow of the pressurized medium discharged from the second wheel cylinder 22 is provided on the second auxiliary dump flow path 1642. Like the first discharge valve 1641a, the second discharge valve 1642a may be provided as a normal closed type solenoid valve that is closed in normal times and operates to open when receiving an electrical signal from the electronic control unit.

The connecting line 400 is provided to hydraulically connect the first block 100 of the mechanical part, the second block 200 of the electronic part, and the emergency module 300, which are spaced apart from each other.

The connecting line 400 may include the first connecting line 410 connecting the master cylinder 1200 of the mechanical part to the first hydraulic circuit 1510 of the hydraulic pressure control unit 1400, the second connecting line 9420 connecting the master cylinder 1200 to the second hydraulic circuit 1520 of the hydraulic pressure control unit 1400 and the pedal simulator 1250, the third connecting line 430 connecting the hydraulic pressure auxiliary device 1600 of the emergency module 300 and the sub reservoir 1100b of the electronic part, and the fourth connecting line 440 connecting the main reservoir 1100a of the mechanical part and the sub reservoir 1100b of the electronic part to each other.

The first connecting line 410 may have one end connected to the first master chamber 1220a of the master cylinder 1200 and the other end connected to a downstream or rear end side of the first and second inlet valves 1511a and 1512a of the first hydraulic circuit 1510.

The first cut valve 411 may be provided in the first connecting line 410 so that a flow of the pressurized medium between the first master chamber 1220a of the master cylinder 1200 and the first hydraulic circuit 1510 is controlled. The first cut valve 411 may be provided as a normal open type solenoid valve that is open in normal times and operates to close when receiving a closing signal from the electronic control unit.

The first cut valve 411 is controlled to be in a closed state in the normal operating mode, which is a general braking situation, and thereby the pressurized medium accommodated in the first master chamber 1220a is not transmitted toward the first hydraulic circuit 1510 despite the pressing force of the brake pedal 10. In addition, the first cut valve 411 is controlled to be in the closed state in the normal operating mode, and thereby the hydraulic pressure of the pressurized medium provided by the hydraulic pressure supply device 1300 may be stably supplied toward the wheel cylinders 21, 22, 23, and 24 without leaking toward the master cylinder 1200 along the first connecting line 410.

However, the first cut valve 411 is put into an open state in the second fallback mode to which the electronic brake system is switched when the electronic part and the emergency module are inoperative, and thereby the pressurized medium discharged from the first master chamber 1220a of the master cylinder 1200 may be supplied to the first and second wheel cylinders 21 and 22 through the first connecting line 410, and thus braking may be implemented.

The second connecting line 420 may be branched into the simulation line 421 having one end connected to the second master chamber 1230a of the master cylinder 1200 and the other end connected to a front end of the pedal simulator 1250 and the backup line 422 connected to a downstream or rear end side of the third and fourth inlet valves 1521a and 1522a of the second hydraulic circuit 1520.

The second cut valve 422a may be provided in the backup line 422 so that a flow of the pressurized medium between the second master chamber 1230a of the master cylinder 1200 and the second hydraulic circuit 1520 may be controlled. The second cut valve 422a may be provided as a normal open type solenoid valve that is open in normal times and operates to close when receiving a closing signal from the electronic control unit.

The second cut valve 422a is controlled to be in the closed state in the normal operating mode, which is a general braking situation, and thereby the pressurized medium accommodated in the second master chamber 1220a is not transmitted toward the second hydraulic circuit 1520 despite the pressing force of the brake pedal 10. In addition, the second cut valve 422a is controlled to be in the closed state in the normal operating mode, and thereby the hydraulic pressure of the pressurized medium provided by the hydraulic pressure supply device 1300 may be stably supplied toward the wheel cylinders 21, 22, 23, and 24 without leaking toward the master cylinder 1200 along the backup line 422.

However, the second cut valve 422a is put into the open state in the second fallback mode to which the electronic brake system is switched when the electronic part and the emergency module are inoperative, and thereby the pressurized medium discharged from the second master chamber 1230a of the master cylinder 1200 may be supplied to the third and fourth wheel cylinders 23 and 24 through the backup line 422, and thus braking may be implemented.

The third connecting line 430 is provided to have one end connected to the sub reservoir 1100b and the other end connected to the hydraulic pressure auxiliary device 1600 of the emergency module 300. Specifically, the other end of the third connecting line 430 may be connected to inlets of the pumps 1620 and the first and second auxiliary dump flow paths 1641 and 1642, thereby supplying the pressurized medium toward the inlets of the pumps 1620 from the sub reservoir 1100b or discharging the pressurized medium to the sub reservoir 1100b from the first and second auxiliary dump flow paths 1641 and 1642.

The fourth connecting line 440 may be provided to have one end communicating with the main reservoir 1100a and the other end communicating with the sub reservoir 1100b. The fourth connecting line 440 may promote smooth supply of the pressurized medium to each component element by allowing the pressurized medium to be transmitted between the reservoirs when the pressurized medium is excessively large or small in a reservoir on one side.

The first connecting line 410 and the second connecting line 420 may be provided as pipes having a predetermined strength, and the third connecting line 430 and the fourth connecting line 440 may be provided as hoses having elasticity. Since the pressurized medium of which the hydraulic pressure is generated is transmitted from the first and second master chambers 1220a and 1230a to the first connecting line 410 and the second connecting line 420, product durability and performance may be promoted by providing the first connecting line 410 and the second connecting line 420 as pipes having a strength capable of withstanding hydraulic pressure. Meanwhile, since the third connecting line 430 and the fourth connecting line 440 are provided to be connected to the main reservoir 1100a or the sub reservoir 1100b having an internal pressure of atmospheric pressure level, the pressurized medium of which hydraulic pressure is not generated is transmitted to the third connecting line 430 and the fourth connecting line 440. Therefore, the third connecting line 430 and the fourth connecting line 440 may be provided as hoses having elasticity to promote ease of installation according to arrangement positions of the first block 100, the second block 200, and the emergency module 300. The first connecting line 410 and the second connecting line 420 may be installed on a vehicle body by a fastening member (not illustrated) having a predetermined restoring force to maintain connectivity despite an impact such as a vehicle accident.

Hereinafter, operation of the electronic brake system 1 according to an exemplary embodiment of the present invention will be described.

The operation of the electronic brake system 1 according to an exemplary embodiment of the present invention may perform the normal operating mode in which various devices and valves operate normally without failure or abnormality, the first fallback mode in which the hydraulic pressure auxiliary device 1600 intervenes as the hydraulic pressure supply device 1300 is inoperative, and the second fallback mode in which both the hydraulic pressure supply device 1300 and the hydraulic pressure auxiliary device 1600 correspond to the inoperative state.

First, the normal operating mode of the electronic brake system 1 according to an exemplary embodiment of the present invention will be described.

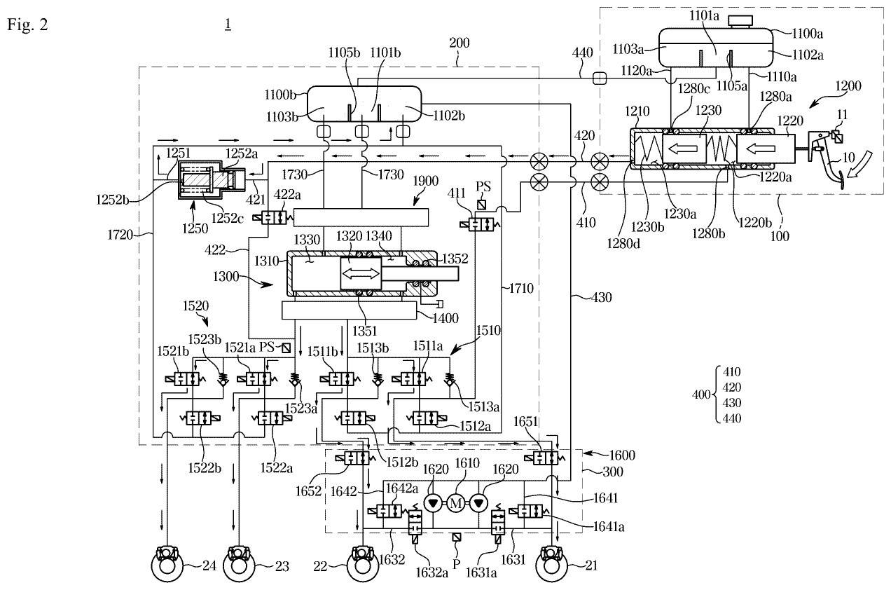

FIG. 2 is a hydraulic circuit diagram illustrating a state in which the electronic brake system 1 according to an exemplary embodiment of the present invention performs a normal operating mode. Referring to FIG. 2, when the driver applies a pressing force to the brake pedal 10 to brake the vehicle, the electronic control unit operates the motor of the hydraulic pressure supply device 1300 in one direction based on displacement information about the brake pedal 10 detected by the pedal displacement sensor 11. The rotational force of the motor is transmitted to the hydraulic pressure providing unit by the power converter, and the hydraulic piston 1320 of the hydraulic pressure providing unit operates to generate hydraulic pressure in the first pressure chamber 1330 or the second pressure chamber 1340. The hydraulic pressure generated in the first pressure chamber 1330 or the second pressure chamber 1340 is transmitted to each of the first to fourth wheel cylinders 21, 22, 23, and 24 through the hydraulic pressure control unit 1400, the first hydraulic circuit 1510, and the second hydraulic circuit 1520, and generates the braking force.

In the normal operating mode, the first cut valve 411 provided in the first connecting line 410 and the second cut valve 422a provided in the backup line 422 of the second connecting line 420 are switched to the closed state, and thus the pressurized medium of the master cylinder 1200 is prevented from being transmitted toward the wheel cylinders, and the hydraulic pressure provided from the hydraulic pressure supply device 1300 is prevented from leaking toward the master cylinder 1200, so that rapid braking may be performed.

In the normal operating mode, the first to fourth inlet valves 1511a, 1511b, 1521a, and 1521b maintain the open state, so that the hydraulic pressure provided from the hydraulic pressure supply device 1300 may be smoothly transmitted to the first to fourth wheel cylinders 21, 22, 23, and 24, and the first to fourth outlet valves 1512a, 1512b, 1522a, and 1522b maintain the closed state, so that the pressurized medium may be prevented from leaking toward the sub reservoir 1100b.

Meanwhile, when the driver applies a pressing force to the brake pedal 10 in the normal operating mode, the first master piston 1220 moves forward and a displacement occurs. At this time, since the first master chamber 1220a is closed as the first cut valve 411 is switched to the closed state, the pressurized medium therein moves the second master piston 1230 forward without being discharged and generates a displacement. By the forward movement of the second master piston 1230, the pressurized medium in the second master chamber 1230a is pressurized, and the pressurized medium in the second master chamber 1230a is transmitted to the pedal simulator 1250 along the second connecting line 420 and the simulation line 421. The pressurized medium transmitted through the second connecting line 420 and the simulation line 421 may move the simulation piston 1252a of the pedal simulator 1252 forward to compress the simulation spring 1252c, and the elastic restoring force generated by the compression of the simulation spring 1252c may be provided to the driver as a pedal feeling. The pressurized medium accommodated in the simulation chamber 1252b of the pedal simulator 1252 is discharged to the sub reservoir 1100b by sequentially passing through the simulation flow path 1251 and the second sub reservoir flow path 1720.

In the normal operating mode, since the hydraulic pressure supply device 1300 is in the normal operating state, the hydraulic pressure auxiliary device 1600 does not intervene, and thus by maintaining the first and second isolation valves 1651 and 1652 in the open state, the hydraulic pressure of the pressurized medium supplied from the hydraulic pressure supply device 1300 may be smoothly provided to the first to fourth wheel cylinders 21, 22, 23, and 24.

Hereinafter, release of the normal operating mode of the electronic brake system 1 according to an exemplary embodiment of the present invention will be described.

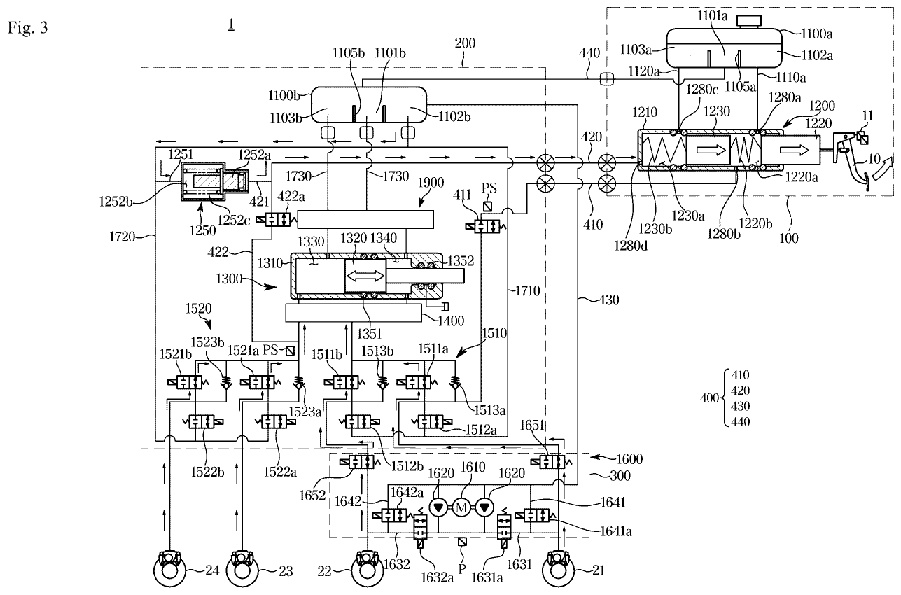

FIG. 3 is a hydraulic circuit diagram illustrating a state in which the electronic brake system 1 according to an exemplary embodiment of the present invention releases the normal operating mode, and referring to FIG. 3, when the pressing force applied to the brake pedal 10 is released, the electronic control unit operates the motor in the other direction based on displacement information about the brake pedal 10 detected by the pedal displacement sensor 11. The rotational force of the motor is transmitted to the hydraulic pressure providing unit by the power converter and operates the hydraulic piston 1320 of the hydraulic pressure providing unit. In this way, a negative pressure may be generated in the first pressure chamber 1330 or the second pressure chamber 1340, and the pressurized medium applied to the first to fourth wheel cylinders 201, 22, 23, and 24 may be recovered to the first pressure chamber 1330 or the second pressure chamber 1340, and thus braking may be released.

In the normal operating mode, the first to fourth inlet valves 1511a, 1511b, 1521a, and 1521b maintain the open state, so that the pressurized medium provided to the first to fourth wheel cylinders 21, 22, 23, and 24 may be smoothly recovered to the hydraulic pressure supply device 1300 through the hydraulic pressure control unit 1400. In addition, in the normal operating mode, since the first cut valve 411 and the second cut valve 422a are closed, the pressurized medium applied to the first to fourth wheel cylinders 21, 22, 23, and 24 may be completely recovered to the first pressure chamber 1330 or the second pressure chamber 1340 of the hydraulic pressure supply device 1300 without leaking into the master cylinder 1200. Meanwhile, the first to fourth outlet valves 1512a, 1512b, 1522a, and 1522b maintain a closed state, but when the pressurized medium applied to the first to fourth wheel cylinders 21, 22, 23, and 24 is to be removed more quickly, the first to fourth outlet valves 1512a, 1512b, 1522a, and 1522b may be selectively opened.

Meanwhile, when the driver removes the pressing force on the brake pedal 10, the first master piston 1220 and the second master piston 1230 are returned to their original positions by the elastic restoring force of the first piston spring 1220b and the second piston spring 1230b. In addition, the simulation piston 1252a of the pedal simulator 1250 is also returned to its original position by the elastic restoring force of the simulation spring 1252c. In this case, the pressurized medium applied to the front surface of the simulation piston 1252a may be recovered to the second master chamber 1230a by sequentially passing through the simulation line 421 and the second connecting line 420, and the simulation chamber 1252b may be refilled with the pressurized medium by sequentially passing through the second sub reservoir flow path 1720 and the simulation flow path 1251.

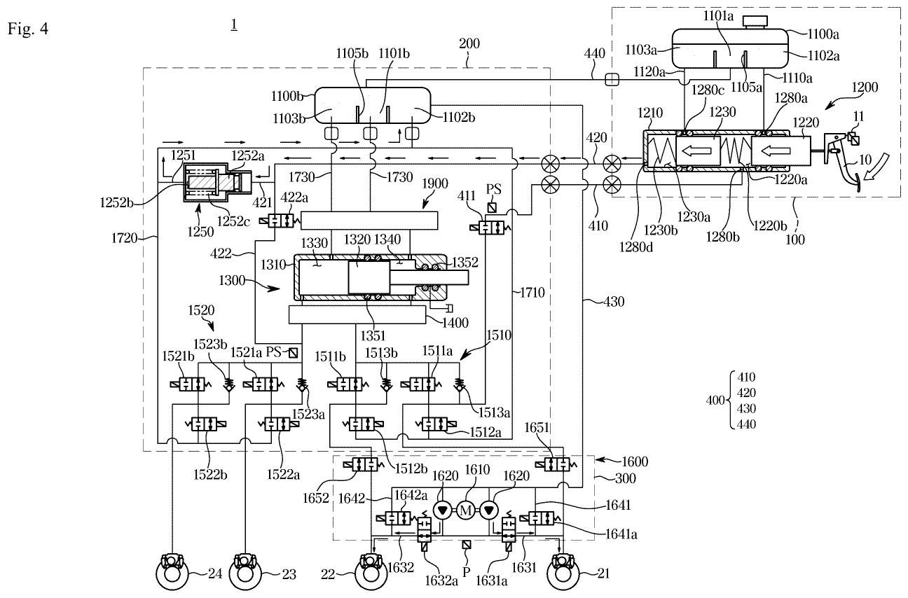

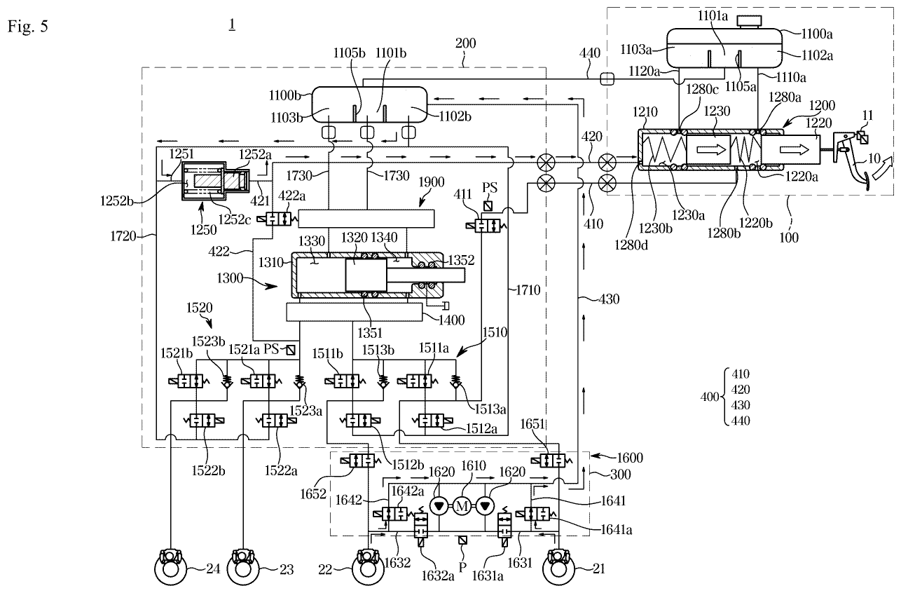

The electronic brake system 1 according to an exemplary embodiment of the present invention may be switched to the first fallback mode illustrated in FIGS. 4 and 5 in the case where the hydraulic pressure supply device 1300 is in an inoperative state such as a failure, a leakage of the pressurized medium, or the like.

FIG. 4 is a hydraulic circuit diagram illustrating a state in which the first fallback mode is performed when the hydraulic pressure supply device 1300 of the electronic brake system 1 according to an exemplary embodiment of the present invention is stopped. Referring to FIG. 4, when the electronic control unit determines that the hydraulic pressure supply device 1300 is in an inoperative state due to a failure or the like, the electronic control unit switches the electronic brake system 1 to the first fallback mode.

When the driver applies a pressing force to the brake pedal 10 in the first fallback mode, the electronic control unit operates the hydraulic pressure auxiliary device 1600 based on displacement information about the pedal brake pedal 10 detected by the pedal displacement sensor 11. When the electronic brake system 1 enters the first fallback mode, the electronic control unit hydraulically isolates the first and second wheel cylinders 21 and 22 from the hydraulic pressure supply device 1300 by operating the first and second isolation valves 1651 and 1652 to be closed.

The electronic control unit may operate the motor 1610 of the hydraulic pressure auxiliary device 1600 based on the displacement information about the pedal, and the pair of pumps 1620 may generate hydraulic pressure of the pressurized medium by the operation of the motor 1610. The pressurized medium of which hydraulic pressure is generated by the pump 1620 may be transmitted to the first and second wheel cylinders 21 and 22 through the first and second auxiliary hydraulic flow paths 1631 and 1632, respectively, and in this case, the first and second support valves 1631a and 1632a respectively provided on the first and second auxiliary hydraulic flow paths 1631 and 1632 are operated in the open state. In addition, by controlling the first and second discharge valves 1641a and 1642a respectively provided on the first and second auxiliary dump flow paths 1641 and 1642 to be in the closed state, the hydraulic pressure of the pressurized medium generated by the pumps 1620 may be prevented from leaking toward the sub reservoir 1100b through the third connecting line 430.

Meanwhile, operations of the master cylinder 1200 and the pedal simulator 1250 in the first fallback mode are the same as the above-described operations in the normal operating mode, and therefore a description of the redundant content will be omitted.

Hereinafter, release of the first fallback mode of the electronic brake system 1 according to an exemplary embodiment of the present invention will be described.

FIG. 5 is a hydraulic circuit diagram illustrating a state in which the electronic brake system 1 according to an exemplary embodiment of the present invention releases the first fallback mode, and referring to FIG. 5, when the pedal displacement sensor 11 detects that the pressing force of the brake pedal 10 is released, the electronic control unit may switch the first and second support valves 1631a and 1632a respectively provided in the first and second auxiliary hydraulic flow paths 1631 and 1632 to the closed state, so that the pressurized medium may be prevented from being transmitted from the motor 1610 and the pumps 1620 to the first and second wheel cylinders 21 and 22. At the same time, by switching the first and second discharge valves 1641a and 1642a respectively provided in the first and second auxiliary dump flow paths 1641 and 1642 to the open state, the pressurized medium applied to the first and second wheel cylinders 21 and 22 may be transmitted to the third connecting line 430 and discharged to the sub reservoir 1100b or discharged toward an inlet of the pumps 1620, and thus braking of the first and second wheel cylinders 21 and 22 may be released.

At this time, the first and second isolation valves 1651 and 1652 may be maintained in the closed state, and thus the pressurized medium applied to the first and second wheel cylinders 21 and 22 may be prevented from being introduced into the hydraulic pressure supply device 1300.

Meanwhile, operations of the master cylinder 1200 and the pedal simulation when the first fallback mode is released are the same as the above-described operations when the normal operating mode is released, and therefore a description of the redundant content will be omitted.

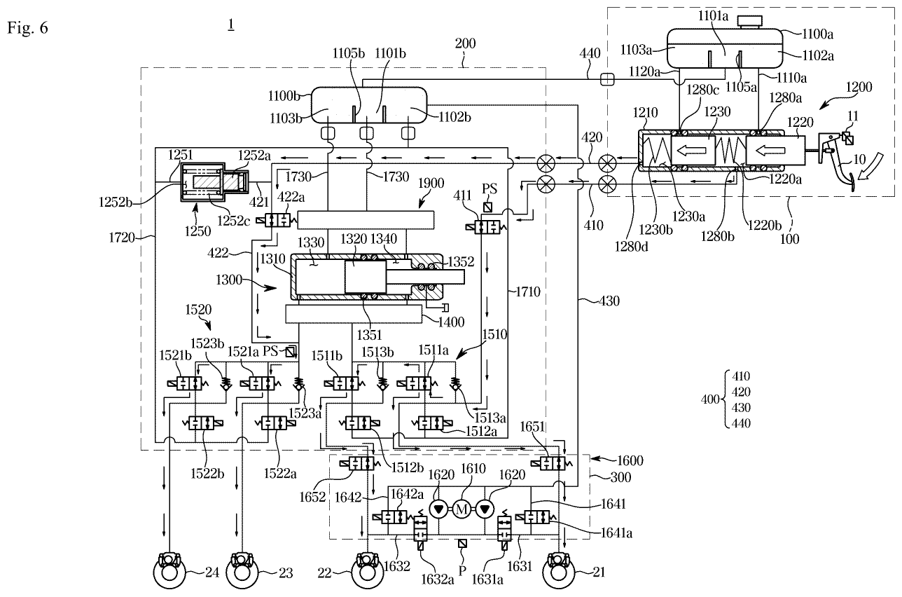

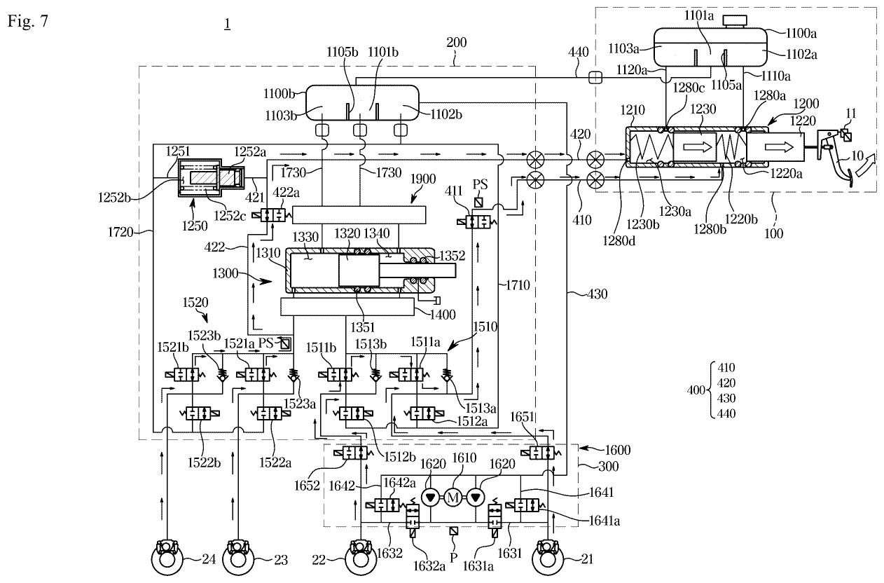

The electronic brake system 1 according to an exemplary embodiment of the present invention may switch the electronic brake system to the second fallback mode illustrated in FIGS. 6 and 7 in the case where not only the hydraulic pressure supply device 1300, but also the hydraulic pressure auxiliary device 1600 is in an inoperative state such as a failure, a leakage of the pressurized medium, or the like.

FIG. 6 is a hydraulic circuit diagram illustrating a state in which the second fallback mode is performed when the hydraulic pressure supply device 1300 and the hydraulic pressure auxiliary device 1600 of the electronic brake system 1 according to an exemplary embodiment of the present invention are stopped. Referring to FIG. 6, when the electronic control unit determines that the hydraulic pressure supply device 1300 and the hydraulic pressure auxiliary device 1600 are in an inoperative state due to a failure or the like, the electronic control unit switches the electronic brake system to the second fallback mode.

In the second fallback mode, each of valves is controlled in a non-operating state. In this case, when the driver applies a pressing force to the brake pedal 10, the first master piston 1220 connected to the brake pedal 10 moves forward and a displacement occurs. Since the first cut valve 411 is provided in the open state in the non-operating state, the pressurized medium accommodated in the first master chamber 1220a may be transmitted to the first hydraulic circuit 1510 along the first connecting line 410 by the forward movement of the first master piston 1220, and thus braking of the first and second wheel cylinders 21 and 22 may be implemented. In this case, since the first and second isolation valves 1651 and 1652 of the hydraulic pressure auxiliary device 1600 maintain the open state, the pressurized medium introduced along the first connecting line 410 may be smoothly transmitted to the first and second wheel cylinders 21 and 22.

At the same time, the pressurized medium accommodated in the first master chamber 1220a moves the second master piston 1230 forward, so that a displacement occurs. Since the second cut valve 422a is provided in the open state in the non-operating state, the pressurized medium accommodated in the second master chamber 1230a may be transmitted to the second hydraulic circuit 1520 along the second connecting line 420 and the backup line 421 by the forward movement of the second master piston 1230, and thus braking of the third and fourth wheel cylinders 23 and 24 may be implemented. Meanwhile, a portion of the pressurized medium accommodated in the second master chamber 1230a may be transmitted to the pedal simulator 1250 along the second connecting line 420 and the simulation line 421 by the forward movement of the second master piston 1230 and provide a pedal feeling to the driver.

Hereinafter, an operation of releasing the second fallback mode by the electronic brake system 1 according to an exemplary embodiment of the present invention will be described.

FIG. 7 is a hydraulic circuit diagram illustrating a state in which the electronic brake system 1 according to an exemplary embodiment of the present invention releases the second fallback mode, and referring to FIG. 7, as the driver releases the pressing force applied to the brake pedal 10, the first and second master pistons 1220 and 1230 which have moved forward return to their original positions by the elastic restoring forces of the first and second piston springs 1220b and 1230b. As the first and second master pistons 1220 and 1230 return to their original positions, negative pressures are generated in the first and second master chambers 1220a and 1230a, the pressurized medium applied to the first and second wheel cylinders 21 and 22 is recovered to the first master chamber 1220a along the first connecting line 410 by the negative pressures, and the pressurized medium applied to the third and fourth wheel cylinders 23 and 24 may is recovered to the second master chamber 1230a along the backup line 422 and the second connecting line 420, and thereby braking of the wheel cylinders may be released.

1. An electronic brake system comprising:
a first block in which a mechanical part mechanically operated in conjunction with a brake pedal is disposed;
a second block in which an electronic part electronically operated and controlled by an electronic control unit is disposed, wherein the second block is spaced apart from the first block;
an emergency module configured to operate when the electronic part is inoperative and provide hydraulic pressure to a wheel cylinder in an auxiliary manner; and
a connecting line hydraulically connecting the first block, the second block, and the emergency module to each other,
wherein the mechanical part includes a master cylinder equipped with a first master piston connected to the brake pedal, a first master chamber whose volume is varied by a displacement of the first master piston, a second master piston provided to be displaceable by hydraulic pressure of the first master chamber, and a second master chamber whose volume is varied by a displacement of the second master piston,
the electronic part includes a pedal simulator, a hydraulic pressure supply device configured to generate hydraulic pressure by operating a hydraulic piston by an electrical signal output in response to a displacement of the brake pedal or an electrical signal output from the electronic control unit, and a hydraulic pressure control unit equipped with a first hydraulic circuit configured to control hydraulic pressure transmitted to first and second wheel cylinders, and a second hydraulic circuit configured to control hydraulic pressure transmitted to third and fourth wheel cylinders, and
the connecting line includes a first connecting line having one end connected to the first master chamber and the other end connected to the first hydraulic circuit and a second connecting line having one end connected to the second master chamber and the other end branched and connected to each of the pedal simulator and the second hydraulic circuit.

2. The electronic brake system of claim 1, wherein the electronic part further includes a sub reservoir in which a pressurized medium is stored,
the emergency module includes a hydraulic pressure auxiliary device configured to operate when the hydraulic pressure supply device is inoperative and provide hydraulic pressure to the wheel cylinder, and
the connecting line further includes a third connecting line having one end connected to the sub reservoir and the other end connected to the hydraulic pressure auxiliary device.

3. The electronic brake system of claim 2, wherein the mechanical part further includes a main reservoir in which the pressurized medium is stored, and
the connecting line further includes a fourth connecting line one end connected to the main reservoir and the other end connected to the sub reservoir.

4. The electronic brake system of claim 1, wherein the other end of the second connecting line is branched into a simulation line connected to a front end of the pedal simulator and a backup line connected to the second hydraulic circuit, and
the electronic part further includes a first cut valve provided in the first connecting line to control a flow of a pressurized medium and a second cut valve provided in the backup line to control the flow of the pressurized medium.

5. The electronic brake system of claim 2, wherein the hydraulic pressure auxiliary device is provided between the first and second wheel cylinders and the first hydraulic circuit.

6. The electronic brake system of claim 5, wherein the hydraulic pressure auxiliary device includes a first isolation valve and a second isolation valve configured to allow and block flows of the pressurized medium transmitted from the master cylinder and the hydraulic pressure supply device to the first wheel cylinder and the second wheel cylinder, respectively, a pump configured to pressurize the pressurized medium, a motor configured to drive the pump, a first auxiliary hydraulic flow path for transmitting the pressurized medium pressurized by the pump to the first wheel cylinder, and a second auxiliary hydraulic flow path for transmitting the pressurized medium pressurized by the pump to the second wheel cylinder.

7. The electronic brake system of claim 6, wherein the hydraulic pressure auxiliary device further includes a first auxiliary dump flow path for discharging the pressurized medium applied to the first wheel cylinder and a second auxiliary dump flow path for discharging the pressurized medium applied to the second wheel cylinder.

8. The electronic brake system of claim 7, wherein the hydraulic pressure auxiliary device further includes a first support valve provided on the first auxiliary hydraulic flow path to control the flow of the pressurized medium and a second support valve provided on the second auxiliary hydraulic flow path to control the flow of the pressurized medium.

9. The electronic brake system of claim 8, wherein the hydraulic pressure auxiliary device further includes a first discharge valve provided on the first auxiliary dump flow path to control the flow of the pressurized medium and a second discharge valve provided on the second auxiliary dump flow path to control the flow of the pressurized medium.

10. The electronic brake system of claim 7, wherein the other end of the third connecting line is connected to an inlet of the pump and the first and second auxiliary dump flow paths.

11. The electronic brake system of claim 2, wherein the electronic part further includes a first sub reservoir flow path connecting the sub reservoir and a rear end of the first hydraulic circuit, and a second sub reservoir flow path connecting the sub reservoir and a rear end of the second hydraulic circuit.

12. The electronic brake system of claim 11, wherein the electronic part further includes a simulation flow path connected to a rear end of the pedal simulator, and
the simulation flow path is connected to the sub reservoir by joining the second sub reservoir flow path.

13. The electronic brake system of claim 11, wherein the electronic part further includes a dump controller provided between the sub reservoir and the hydraulic pressure supply device to control the flow of the pressurized medium and a third sub reservoir flow path connecting the sub reservoir and the dump controller.

14. The electronic brake system of claim 11, wherein the first hydraulic circuit includes a first inlet valve and a second inlet valve configured to control the flow of the pressurized medium supplied from the hydraulic pressure supply device to the first wheel cylinder and the second wheel cylinder, respectively, and a first outlet valve and a second outlet valve configured to control flows of the pressurized medium discharged from the first wheel cylinder and the second wheel cylinder, respectively,
the second hydraulic circuit includes a third inlet valve and a fourth inlet valve configured to control flows of the pressurized medium supplied from the hydraulic pressure supply device to the third wheel cylinder and the fourth wheel cylinder, respectively, and a third outlet valve and a fourth outlet valve configured to control flows of the pressurized medium discharged from the third wheel cylinder and the fourth wheel cylinder, respectively,
the pressurized medium discharged through the first and second outlet valves is supplied to the first sub reservoir flow path, and
the pressurized medium discharged through the third and fourth outlet valves is supplied to the second sub reservoir flow path.

15. The electronic brake system of claim 3, wherein the first connecting line and the second connecting line are provided as pipes having rigidity, and
the third connecting line and the fourth connecting line are provided as hoses having elasticity.
